(19) United States
(12) Patent Application Publication
(10) Pub. No.: US 2024/0187396 A1
(43) Pub. Date: Jun. 6, 2024

(54) COMPLIANCE HUB

(71) Applicant: Shieldhub Limited, Tralee (IE)

(72) Inventors: Michael Joseph O'Connor, Tralee (IE); Scott Sorenson, Cork (IE); Sean Ryan, Ardfert (IE)

(73) Assignee: Shieldhub Limited, Tralee (IE)

(21) Appl. No.: 18/439,892

(22) Filed: Feb. 13, 2024

Related U.S. Application Data
(63) Continuation of application No. 17/217,422, filed on Mar. 30, 2021.

(51) Int. Cl. H04L 9/40

(52) U.S. Cl. CPC H04L 63/0815

(57) ABSTRACT

The invention is that of a system and method of generating an individual compliance score based on one or more background checks that is useful in determining the compliance levels of service providers based on selected criteria. The individual compliance scores are the result of a matrix comparison of a background check score against industry standards to provide greater weight to areas of specific interest depending on the industry. An application program interface may be installed on a user system to allow individual compliance scores and corresponding unique identifiers to be visible to users of the system. Access and security controls are provided, with users being in network communication with the system. The methods enabled by the system allow for rapid real-time service provider qualification without the need for time consuming background audits. A system of the present invention may be presented as a feature of an existing mobile application.

### CROSS-REFERENCE TO RELATED APPLICATIONS

This application is a continuation of U.S. patent application Ser. No. 17/222,250, filed Apr. 5, 2021, which claims the benefit of priority of U.S. Provisional Patent Application Ser. No. 63/005,078, filed Apr. 3, 2020, the contents of which are hereby incorporated by reference in their entirety.

### STATEMENT REGARDING FEDERALLY SPONSORED RESEARCH OR DEVELOPMENT

The invention described herein was conceived and reduced to practice without the benefit of federal funding.

### BACKGROUND OF THE INVENTION

In the insurance industry, when a claim is made, the insurer may assign outsourced service providers to travel to a site of an insured for the purpose of servicing the claim, i.e., assessing damage and making repairs. In many cases the assignment of contractors by an insurer on behalf of an insured may be handled by third party administrators as opposed to internally by the insurer. In addition, a contractor hired to service a claim may subcontract some or all of the work to be performed to a fourth party, and that party may even subcontract a portion of the work to be done to a fifth party, and so on. The insurer may rely on its third-party administrator to make sure all contractors have conducted appropriate background checks on their own personnel and require the same of any subcontractors, for example. It is important in the insurance and other industries to ensure that contractors hired to perform work on the site of an insured or other party are properly qualified with criminal background checks and the like prior to dispatch. This situation is not unique to the insurance industry, but the insurance industry may perhaps have some of the most exacting standards with respect to background checks.

Yet background checks can range widely in depth and breadth depending on cost, ranging from an inexpensive background check that simply confirms the identity of the person being assessed to a background check that may cost hundreds of dollars and reports on results from every court in every jurisdiction in which the person being checked has resided in the past. This causes a high level of uncertainty as to the quality of the background check, and in turn the criminal history of individual being assessed, for an insurer or other business looking to outsource work to that individual. While a prospective contractor can state that all its employees have undergone background checks, the scope of the background checks conducted may not measure up to the appropriate standards. Because of the foregoing, businesses will often physically audit and review the background check reports run by their contractors, for example, to ensure that they are reliable indicators of compliance with various industry standards. This is a time-consuming process that involves the training of auditors and delays in the commencement of projects.

Also missing from the art is a clear standard with a consistent scoring mechanism and a unique number that can be trusted to quickly and efficiently demonstrate that a background check is of high quality and run by a certified consumer reporting agency (CRA), all without having to train someone on how to read a background check report while remaining compliant with all local and state laws regarding the use of background check reports. It is an object of the present invention to provide such a reliable standard, which is absent from the current state of the art. Individuals and businesses can then be notified as to who will be visiting their property to carry out work and be assured that the individual has been qualified against a clear, robust standard, providing peace of mind. It is a further object of the invention to provide a virtual compliance hub that not only allows for the qualification of outsourced personnel against the standard, but also allows each person performing work on a site to make his or her individual compliance rating visible to those seeking services of the type performed by that individual, and to sign in and out at the property visited, thereby providing proof of service by a professional who has been qualified against the standard, and to allow authorized users to log in and view the compliance levels of various individuals according to one aspect of the invention.

### SUMMARY OF THE INVENTION

The invention of the present disclosure comprises embodiments of a systems and methods for the qualification of personnel based on a standard derived from certified CRA inputs obtained from any number of jurisdictions that can be expressed numerically for ease of understanding and associated with the identity of a person evaluated using the system, all while maintaining the privacy of the personally identifying information (PII) of the person evaluated. It is an object of the invention to enable organizations to have governance, compliance and risk management controls as it relates to their employee and contractor networks while simplifying compliance and reducing third-party risk and cost. There is a long felt need among individuals and businesses to have peace of mind regarding the qualifications of persons working on their property and knowledge that the person has undergone a thorough, quality-controlled criminal background check. The meeting of that need is one object of the invention.

It is another object of the present invention to provide a clear industry standard that can be used to by users of the systems and methods as described herein to determine whether prospective contractors meet their specific compliance requirements based on the incorporation of various industry standards related to background checks. It is an object of the invention to provide a standard, generated through a compliance matrix enabled by a system as described herein, that measures individual compliance (IC) scores of screened individuals against industry-specific requirements to determine industry-specific IC levels based on criminal history data, court records and other factors of interest in a way that may be customized depending on the information of interest to various industries and how the industries weigh that information in engaging personnel.

In accordance with a method of the present invention, a CRA that is certified to carry out the method may collect PII such as name, address, social security number, etc. of an individual and associate a unique Assigned Background Compliance (ABC) number with that individual. From there, the CRA can generate an IC score based on background check information and submit an ABC number and corresponding IC level into a system of the present invention via a locally or remotely installed application program interface (API) provided with appropriate authentication and security measures. Since ABC numbers do not directly incorporate any PII, it is another object of the invention to provide users with valuable information on IC levels while maintaining the privacy of individuals associated with ABC numbers.

The invention of the present disclosure allows for network oversight in the form of real-time visibility of every employee, vendor, contractor, subcontractor, or field professional working for a user of the systems and methods as described herein. The systems and methods described herein also incorporate tracking functionalities such that a full audit history of every customer employees or third-party contractors of a user visit is made available. These and other advantages of the present invention will be apparent to one of ordinary skill in the art.

### BRIEF DESCRIPTION OF THE DRAWINGS

FIG. 1 illustrates a process flow of a method according to an embodiment of the present invention.

FIG. 2 illustrates the flow of benefits to users of the present invention.

FIGS. 3A-3D illustrate a flow chart according to exemplary methods of the present invention.

### DETAILED DESCRIPTION OF THE INVENTION

The invention of the present disclosure comprises embodiments of a system and method that leverage technology to aggregate data from multiple sources into a matrix on which calculations may be based to aid in the interpretation of that data for a selected purpose, and in preferred embodiments, for the qualification of outsourced service providers and their personnel against a standard defined by a system as described herein. The basic data inputs into a system as described herein may include court records, law enforcement records, individual criminal histories, professional qualifications, and other data specific to individuals that may be useful in determining whether prospective contractors meet specified compliance requirements based on the incorporation of various industry standards related to background checks into a standard that is represented by a numerical score, based on the comprehensiveness of a given background check and the results returned. According to a method of the present invention, a certified CRA in network communication with a system of the present invention via an API of the present invention supplies background check information to be compared against a matrix useful in generating individual IC scores and ABC numbers, which may be made available to selected viewers based on user preferences.

As explained above, there is a need in the art for reliable standard for determining an IC score for individuals performing various types of services on the property of a customer that takes into account the quality of a background check to which the individual has been subjected as well as standards applicable to an industry or a particular type of service to be provided. Since not all background checks are equivalent in scope and some industry standards, for example insurance and mortgage industry standards, are more exacting than others, the lack of a standard may lead to the retention of underqualified personnel or failure to engage qualified personnel, neither of which is desirable. In accordance with the present invention, an individual or business may request a standardized, fit for purpose background check to be run by any certified CRA that has been independently certified to utilize a system and method of the present invention, which will then generate ABC numbers and associated IC scores as described for individuals screened by the certified CRA, which can then rapidly inform users of the system whether a screened individual meets specific standards of an industry.

In accordance with the present invention, IC scores may be obtained for any subject of a background check by a certified CRA. The IC score for an individual is generated when the CRA has obtained all the necessary PII and run a selected background check. An IC score will be based on the contents of the selected background check report and may be submitted over a network via an installed API compatible with a system of the present invention, along with a request for an ABC number that is unique to each individual but free of any PII that might be obtained by malicious actors such as hackers. From there, an IC score is generated against a matrix that considers various industry requirements, the quality of the background check to which each individual has been subjected, and the results returned, thereby providing a customized output for interested parties. Such a matrix may include factors that are industry-specific or specific to the type of service to be performed by the individual represented by the ABC number and IC score, as the scope of legally applicable records may vary across industries and technical disciplines or trades. It is an object of the present invention to place the most weight behind legally applicable records for the appropriate customer industry.

In certain embodiments, a customer API may be provided according to a system of the present invention which allows an authorized party other than a CRA to access the system and view IC scores by ABC number to determine the compliance level of individuals of interest according to an IC scoring system as described herein. As will be appreciated by one of ordinary skill in the art, an API as described herein may be locally or remotely installed and include authentication protocols and other security features to prevent unauthorized access or use of the system. Access profiles will be different for customers compared to CRAs, with only CRAs provided with the ability to input data into the system for the return of IC scores and corresponding ABC numbers.

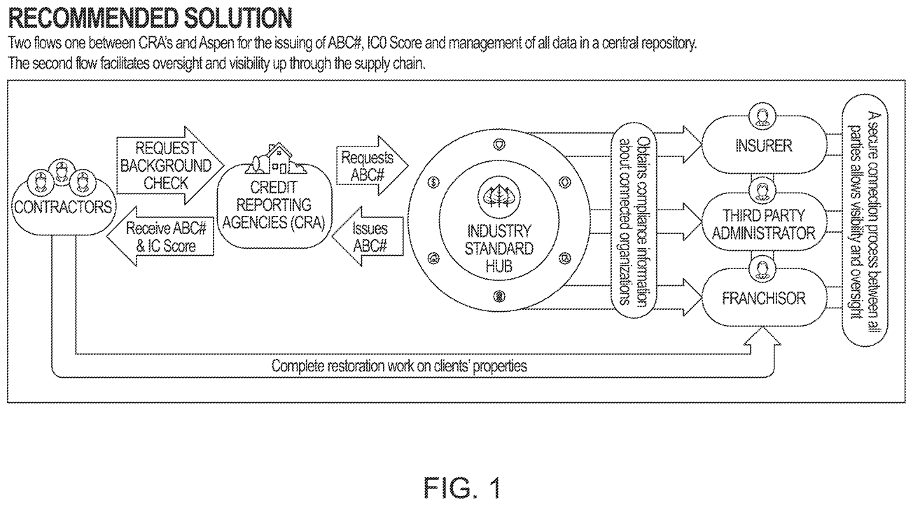

Turning now to FIG. 1, a contractor interested in being scored, or in the case of the contractor being a business organization, having its personnel scored, may submit individual PII to a CRA that has been certified to use a system of the present invention to submit the PII for background check by one or more selected providers. In certain embodiments, the background check data obtained by the CRA are then transmitted via secure API in network communication with a system as described herein for processing. An exemplary system of the present disclosure comprises a non-transitory computer readable storage medium, further comprising software applications for carrying out the methods according to the invention, as well as a database containing the necessary inputs and outputs. In certain embodiments, the CRA data inputs are contained within a database as will be familiar to one of ordinary skill in the art, which may be organized or filtered by CRA or data input type. In certain embodiments, a system of the present invention further comprises a comparison matrix, also tangibly stored on a non-transitory computer readable medium in a same or different location as that where the CRA data inputs are stored.

In one aspect, a system of the present invention further comprises a software program tangibly stored on a non-transitory computer readable medium in network communication with a database comprising the CRA data inputs. In preferred embodiments, a software module as described herein is in network communication with at least one processor and contains instructions which when executed by the processor cause the processor to measure CRA data inputs against a comparison matrix to generate an IC score, which can then be communicated back to the CRA. An exemplary method of the present disclosure further comprises the CRA requesting and ABC number and the software module causing the processor to generate the ABC number based on the PII submitted by the CRA in connection with a background check of the individual represented by the PII. Thus, a database of IC numbers and corresponding ABC numbers can be generated and made available on a system of the present invention. This feature may be referred to hereinafter as a “compliance hub”.

In certain embodiments, a subject API, distinct from a CRA API, may be installed on any suitable computing means such as a desktop computer, laptop, tablet or smartphone, allowing a data subject (i.e., contractor wishing to obtain an ABC number and IC score) to interact with a system of the present invention through a user interface. The data subject may elect to make his or her ABC number and IC score visible to selected parties. This feature may allow individuals and organizations in network communication with a system of the present invention to view ABC numbers and associated IC scores stored within the system to help determine whether a given individual has a given IC score. In one aspect, parties with such visibility may be providers of oversight and risk management services in a position to advise on risk associated with work being assigned to individuals and organizations. This enables individuals and organizations from any industry in network communication with a system as described herein may search for and find individuals with desired, validated IC scores rather than running an audit as is the current industry practice. Thus, a method according to the present invention of determining IC scores is not affected by the subjectivity of current methods of background check interpretations and the like, even by trained auditors, and saves valuable time. For example, someone seeking an event caterer may not view a minor drug possession charge as an important factor for individual compliance, but someone seeking a contractor to perform major electrical restoration work in the wake of severe weather damage to a building may not want to assume any risk that an individual performing work on the damaged site has a history of drug use.

It is another object of the invention described herein to enable third parties to embed an API into their proprietary applications to enable homeowners and other consumers to validate an ABC number against an individual's IC score, providing the homeowners and consumers with peace of mind as to who will be visiting or working at their property. For example, a franchisor, third party administrator or insurer as depicted in FIG. 1 may obtain ABC numbers and corresponding IC scores from the compliance hub to expedite claims management, and may embed an API of the present invention in their proprietary systems and provide access to the insureds to aid the insureds in determining contractor compliance levels.

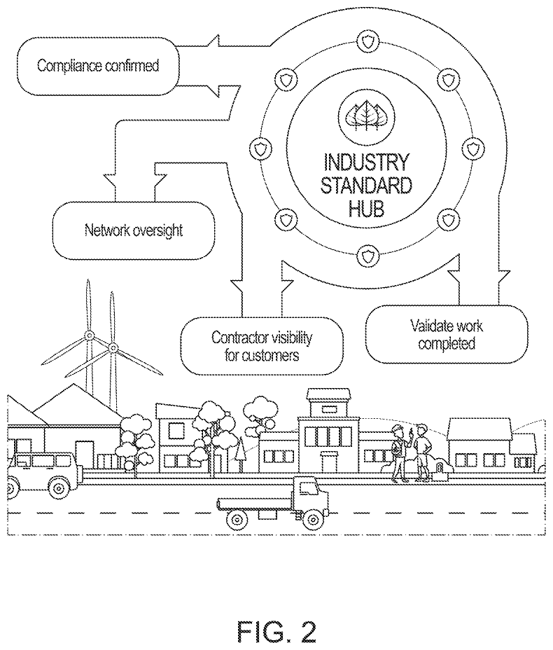

Turning to FIG. 2, it is another object of the invention to improve proof of compliance by giving individuals with ABC numbers the ability to sign in at a location using the ABC number and tie their IC scores with geospatial location information, enabling work providers to know who was working at a property, when they were working, what his or her IC score is and when the work was completed. As one of ordinary skill in the art will appreciate, a system of the present invention may enable methods to be used by anyone interested in qualifying individuals for work on their properties based on the input criteria of such a system. For example, a system as described herein might enable methods to understand compliance levels of personnel such as construction contractors, landscaping contractors, childcare providers, elder care providers, cleaning service providers or any other type of provider who has occasion to come onto one's private property or carry out services that are best subject to scrutiny.

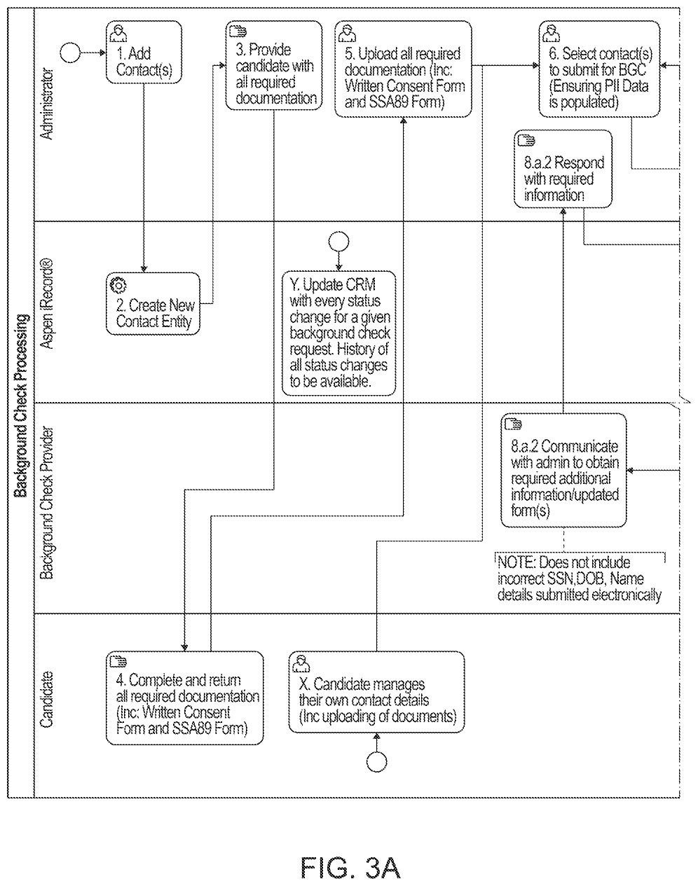

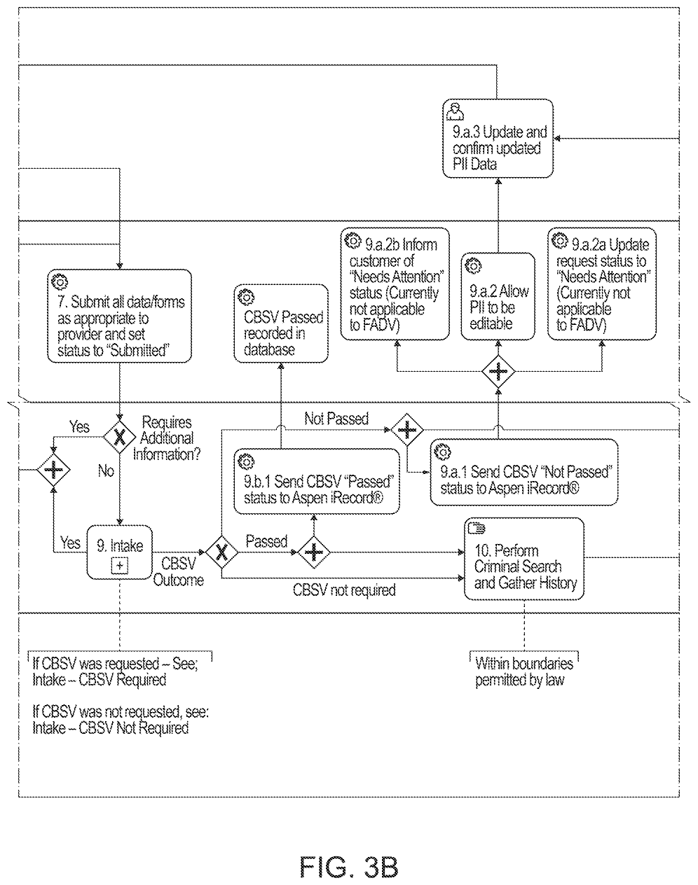

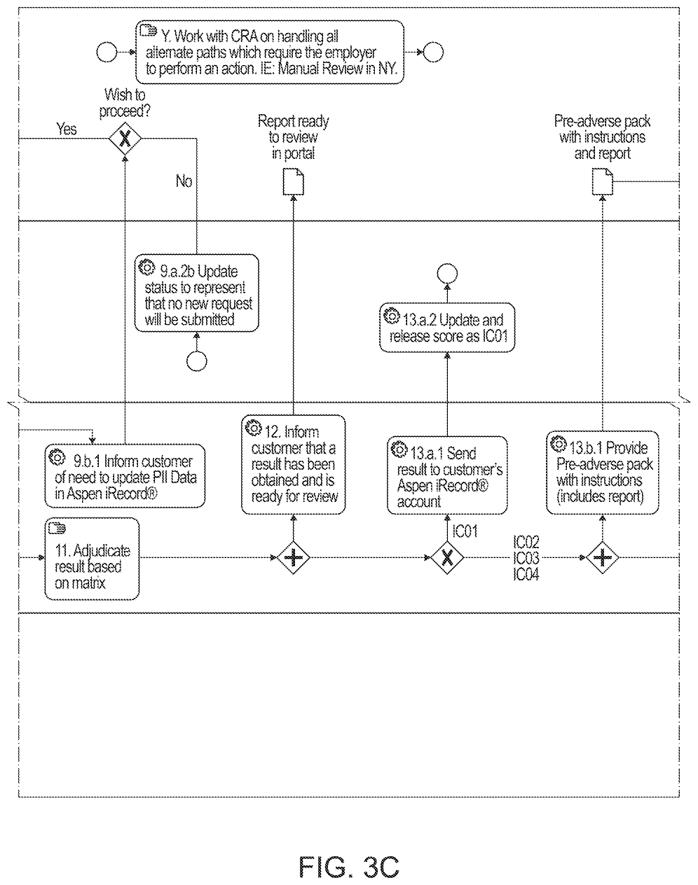

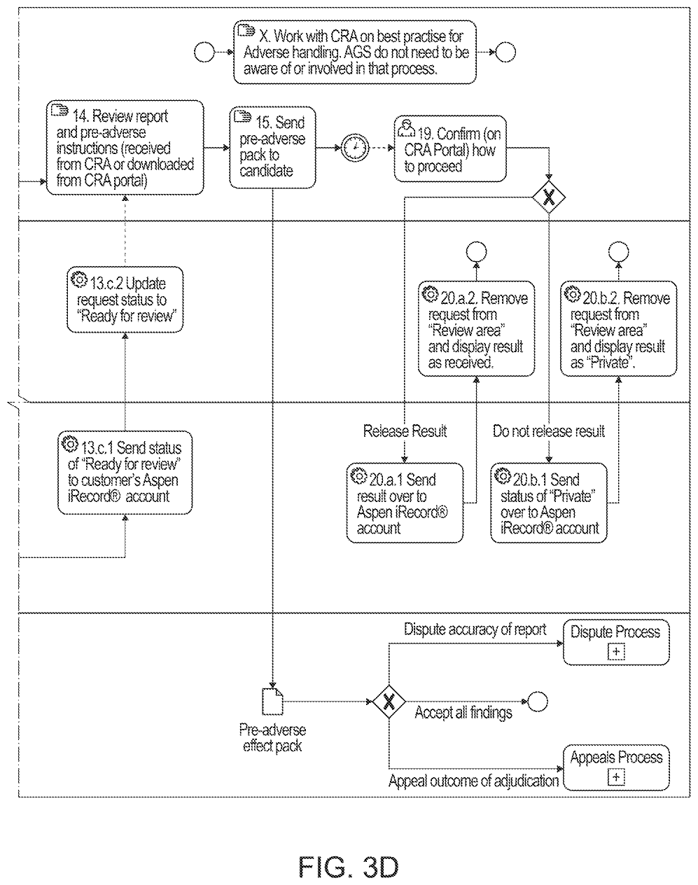

FIG. 3 illustrates an exemplary process flow according to a method of the present disclosure. In this embodiment, a valid administrator may add PII for various candidates wishing to be rated according to a method of the present invention. The PII is communicated to a system as described herein and the system—identified here as Aspen iRecord®—generates a new contact record and associates it with an ABC number, which is communicated to each candidate along with documentary documentation requirements needed for the generation of an IC score, including a written consent form, for example. As the documentation is uploaded, an associated customer resource management (CRM) platform is updated accordingly with each status change as the candidate information is processed and requirements met. In the event a third-party administrator is not used, a candidate having an installed API may supply its own PII into the system for like processing.

Continuing on with FIGS. 3A-3D, once the required information has been uploaded by a candidate or third-party administrator, all associated data are submitted to a selected background check provider (BGC) to initiate the desired background check. If necessary, the BGC may communicate with the candidate or his or her third-party administrator to obtain any additional information needed. Once all required information is received by the BGC and validated, it is fed into the selected criminal search platform, or if the information contains errors or omissions, a notification is sent to the submitter to allow for appropriate editing of the information inputs originally submitted, followed by updated submission.

Once the aforementioned steps have been carried out, the BGC output is processed according to instructions provided by a software module of a system as described herein, i.e., by applying a selected industry standard comparison matrix to the BGC output in order to generate an IC number from IC0I-IC04. If the score is IC0I, IC0I being the “highest” score, indicative of an extremely low risk profile, a database containing IC outputs is updated to correlate the applicable ABC number with the IC0I score. If a candidate is scored as !CO2-IC04, a set of instructions (“pre-adverse pack”) is transmitted to the supplier of the information, which may vary depending on industry and risk tolerance.

Based on the IC score, a third-party administrator or independent candidate may correct supplied information, dispute the score, or appeal the score using a system according to the present disclosure. Once a score is adjudicated as final according to the aforementioned processes, the score is updated, and the submitter is notified on how to proceed. This enables a user to have its results posted in a database containing ABC numbers and corresponding IC scores and described herein, or a user may elect to keep this information private or viewable only by selected individuals or entities.

It is an object of the invention of the present disclosure to take the guesswork out of determining the suitability of contractor and subcontractor personnel in particular for being selected as service providers. By utilizing a system and method as described herein, one can obtain an objective representation of suitability based on a defined standard measured against industry-dependent matrices. This eliminates the requirement some businesses have for auditing contractors and subcontractors for compliance with background check requirements. The ability to quickly and efficiently demonstrate that a background check is of high quality and run by a certified CRA, all without having to train someone on how to read a background check report while remaining compliant with all local and state laws regarding the use of background check reports, is a further object of the present invention. The ABC number as a unique identifier also offers a layer of data privacy protection not available to subjects of background checks according to the current state of the art.

It should be noted that the objects of the present invention set forth above are not available according to the current state of the art, though there has been a long felt need in the art for a system that makes the benefits described herein available. It should be pointed out that the CRAs used to carry out the methods described herein are certified against the same standard as the background check subjects being investigated by certified CRAs, adding another level of compliance.

In certain aspects of the invention, an embedded API may be installed in a manner that allows a customer to import ABC numbers and IC scores corresponding thereto into their human resource management systems and optionally make that information available to third parties. For example, in insurer may leverage an installed API of the present invention to enhance the utility of an existing user application that allows an insured to understand the IC level of a service provider who has been dispatched to an end user's property to perform services. In another aspect, the service provider may be able to sign in and out of a work site, allowing for the tracking of personnel and IC ratings in the performance of work by an enterprise.

The systems and methods of the present disclosure simplify the process of reviewing background check reports, saving time and money, and remove ambiguity, interpretation and bias from hiring processes, ultimately reducing costs of internal monitoring and compliance auditing. The systems and methods described herein allow users to promptly identify third-party compliance risks and undertake corrective action. This can significantly improve the reputation of users and overall good will by differentiating users from competitors as compliant and trusted businesses. These and other benefits of the invention of the present disclosure will be readily apparent to one of ordinary skill in the art.

What is claimed:

1. A method for selecting a third-party service provider, the method comprising:
entering personally identifiable information (PII) corresponding to the third-party service provider to a database via an application program interface (API) in network communication with the database, the database being in network communication with a non-transitory computer readable medium comprising software program instructions, wherein the software program instructions when executed by a computer processor cause the computer processor to transmit data requirements to the third-party service provider;
generating a unique identifier representing the PII but not containing any of the PII;
uploading the required data to the database via an API in network communication therewith;
transmitting the PII and required data to a background check agent (BGC) and obtaining from the BGC the results of a background check;
calculating an individual compliance (IC) score by comparing the background check results against a comparison matrix; and
in response to a user query, presenting the IC score and corresponding unique identifier visually to the user;
wherein the IC score and unique identifier correspond to the third-party service provider.

2. The method of claim 1, wherein the unique identifier is a number and the PII is validated using consent-based social security verification.

3. The method of claim 2, the results of the background check are selected from the group consisting of consumer reporting agency (CRA) records, criminal records, or combinations thereof.

4. The method of claim 3, wherein the comparison matrix is based on standards applicable to a specific industry.

5. The method of claim 4, wherein the industry is selected from the group consisting of the insurance industry and the mortgage industry.

6. The method of claim 5, wherein the IC score is selected from the group consisting of ICO1, ICO2, IC03 and IC04, wherein the risk associated with the third-party service provider increases from ICO1-IC04.

7. The method of claim 6, the method further comprising a means of challenging the IC score and changing the score based on additional data.

8. The method of claim 6, further comprising the step of publishing the IC score to a group of individuals selected by the third-party service provider.

9. The method of claim 7, further comprising the step of publishing the IC score to a group of individuals selected by the third-party service provider.

10. A system for selecting a third-party service provider, the system comprising:
a database comprising PII of at least one third-party service provider in network communication with an API enabling entry of the PII into the database and a first software module tangibly stored on a non-transitory computer readable medium, wherein the first software module comprises instructions which when executed by a computer processor cause the computer processor to generate a number representing the PII but not containing any of the PII and transmit data requirements to the third-party service provider, wherein the third party service provider transmits the required data to the database, where it is associated with the PII.

11. The system of claim 10, further comprising a second software module tangibly stored on a non-transitory computer readable medium and a comparison matrix, wherein the second software module comprises instructions which when executed by a connected computer processor cause the computer processor to generate an IC score by multiplying the PII and required data by the comparison matrix.

12. The system of claim 11, wherein the IC score is selected from the group consisting of ICO1, ICO2, IC03 and IC04.

13. The system of claim 12, wherein the risk associated with the third-party service provider increases from ICO1-IC04.

14. The system of claim 13, the method further comprising a means of challenging the IC score and changing the score based on additional data.

15. The method of claim 14, further comprising the means of publishing the IC score to a group of individuals selected by the third-party service provider.
